(19) United States
(12) Patent Application Publication
(10) Pub. No.: US 2022/0410733 A1
(43) Pub. Date: Dec. 29, 2022

(54) POWER TRANSFER SYSTEM, POWER TRANSMISSION SYSTEM, POWER TRANSFER METHOD

(71) Applicant: TOYOTA JIDOSHA KABUSHIKI KAISHA, Toyota-shi (JP)

(72) Inventors: Toshihiro Nakamura, Sunto-gun (JP); Katsuya Kobayashi, Okazaki-shi (JP); Hiroki Murata, Gotemba-shi (JP); Hiroshi Matsumori, Mishima-shi (JP); Naohiro Seo, Sunto-gun (JP); Akihiro Kusumoto, Susono-shi (JP)

(73) Assignee: TOYOTA JIDOSHA KABUSHIKI KAISHA, Toyota-shi (JP)

(21) Appl. No.: 17/843,366

(22) Filed: Jun. 17, 2022

(30) Foreign Application Priority Data
Jun. 24, 2021 (JP) 2021-104688

(51) Int. Cl. B60L 53/124; H02J 50/10; H02J 50/60; B60L 15/20; B60L 53/30

(52) U.S. Cl. CPC B60L 53/124; H02J 50/10; H02J 50/60; B60L 15/2009; B60L 53/30

(57) ABSTRACT

A power transfer system includes: a compact mobility; a ground unit disposed on a second lane which is a driving lane for the compact mobility, the ground unit being capable of wireless power transfer; and a controller that controls the ground unit. The compact mobility has an amount of electric power that can be stored less than a predetermined amount, and travels at a speed dependent on electric power wirelessly received from the ground unit. When a pedestrian is sensed in the second lane, the controller forces the compact mobility to decelerate by reducing transmission power from the ground unit to the compact mobility, as compared to when the pedestrian is not sensed in the second lane.

This nonprovisional application is based on Japanese Patent Application No. 2021-104688 filed on Jun. 24, 2021 with the Japan Patent Office, the entire content of which is hereby incorporated by reference.

### BACKGROUND

### Field

The present disclosure relates to a power transfer system, a power transmission system, and a power transfer method, and, more particularly, to techniques for wireless power transfer.

### Description of the Background Art

Japanese Patent Laying-Open No. 2012-165497 discloses a controller which controls wireless power feed from the power feed on the ground to the power receiver at a vehicle. Specifically, if sensed the presence of living being around the power feed during the feed operation, the controller regulates the electric power to be fed to the power receiver, as compared to during the feed operation when no presence of living being is sensed.

### SUMMARY

People, such as pedestrians can be present around the power transfer system. Under such circumstances, the focus is how the safety and comfort should be ensured for the surrounding people. An object of the present disclosure is to ensure the safety and comfort for people around the power transfer system.

(1) A power transfer system according to a certain aspect of the present disclosure includes: a movable body; a power transmission device capable of wireless power transfer, the power transmission device being installed on a driving lane for the movable body; and a controller that controls the power transmission device. The movable body has an amount of electric power that can be stored less than a predetermined amount, and travels at an upper speed limit dependent on the electric power wirelessly received from the power transmission device. When a pedestrian is sensed in the driving lane, the controller forces the movable body to decelerate by reducing transmission power from the power transmission device to the movable body, as compared to when the pedestrian is not sensed in the driving lane.

With the configuration (1) above, if a pedestrian is sensed in the driving lane, the transmission power from the power transmission device is reduced and the movable body is decelerated, as compared to when no pedestrian is sensed in the driving lane. The reduction of the transmission power from the power transmission device can mitigate the impact that can be caused on the pedestrian by the electromagnetic field formed around the power transmission device. In addition, the deceleration of the movable body can lessen the feeling of fear that the pedestrian may experience. Thus, according to the configuration (1) above, the safety and comfort of people around the power transfer system are ensured.

(2) The controller forces the movable body to decelerate by reducing the transmission power from the power transmission device to the movable body during a predetermined time period, as compared to other time period.

According to the configuration (2) above, the safety and comfort can be ensured for the surrounding people even during a predetermined time period (e.g., a crowded time period).

(3) The controller gives notification to the movable body, indicating that the transmission power from the power transmission device to the movable body has been reduced. Upon receiving the notification, the movable body further decelerates, in accordance with an operation performed by a driver of the movable body.

According to the configuration (3) above, the movable body is further decelerated, thereby further ensuring the surrounding people's comfort.

(4) The movable body includes a notification unit that notifies the pedestrian that the movable body has decelerated with reduction of the transmission power from the power transmission device.

According to the configuration (4) above, people around the movable body are allowed to know that the traveling speed of the movable body has decreased, further ensuring the surrounding people's comfort.

(5) In a power transmission system for transmitting electric power to a movable body according to another aspect of the present disclosure, the movable body has an amount of electric power that can be stored less than a predetermined amount, and travels at an upper speed limit dependent on electric power received wirelessly. The power transmission system includes: a power transmission device disposed on a driving lane for the movable body, the power transmission device being capable of wireless power transfer to the movable body; and a controller that controls the power transmission device. When a pedestrian is sensed in the driving lane, the controller forces the movable body to decelerate by reducing transmission power from the power transmission device to the movable body, as compared to when the pedestrian is not sensed in the driving lane.

According to the method (5) above, the safety and comfort can be ensured for the surrounding people, similarly to the configuration (1) above.

(6) A power transfer method according to a still another aspect of the present disclosure transfers electric power from a power transmission device to a movable body. The power transmission device is disposed on a driving lane for the movable body, the power transmission device being capable of wireless power transfer to the movable body. The movable body has an amount of electric power that can be stored less than a predetermined amount, and travels at an upper speed limit dependent on the electric power wirelessly received from the power transmission device. The power transfer method includes: sensing a pedestrian in the driving lane; and forcing, when the pedestrian is sensed in the driving lane, the movable body to decelerate by reducing transmission power from the power transmission device to the movable body, as compared to when the pedestrian is not sensed in the driving lane.

According to the method (6) above, the safety and comfort can be ensured for the surrounding people, similarly to the configuration (1) above.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing installation conditions of a power transfer system according to an embodiment of the present disclosure.

FIG. 2 is a diagram illustrating one example configuration of a wireless power transmission system.

FIG. 3 is a diagram illustrating one example mode of a second lane.

FIG. 4 is a diagram illustrating one example of a time course of transmission power from the wireless power transmission system and a time course of a traveling speed of a compact mobility.

FIG. 5 is another diagram illustrating another example of a time course of transmission power from the wireless power transmission system and a time course of a traveling speed of the compact mobility.

FIG. 6 is a flowchart illustrating a procedure of a power transmission process according to the present embodiment.

### DESCRIPTION OF THE PREFERRED EMBODIMENTS

Hereinafter, an embodiment according to the present disclosure will be described in detail, with reference to the accompanying drawings. Note that the same reference sign is used to refer to the same or like parts, and the description thereof will not be repeated.

### EMBODIMENT

<Installation Conditions of Power Transfer System>

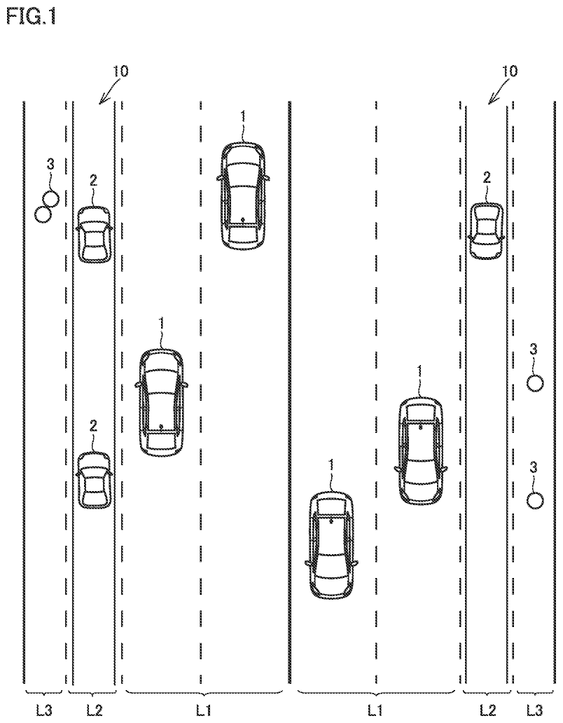

FIG. 1 is a diagram schematically showing installation conditions of a power transfer system according to an embodiment of the present disclosure. In this example, assume a circumstance in which a first lane L1, a second lane L2, and a third lane L3 are provided for each of two directions.

The first lane L1 is where a vehicle 1 can travel at a high speed. The vehicle 1 is, for example, a zero-emission mobility, such as a battery electric vehicle (BEV) or a fuel cell electric vehicle (FCEV). However, the vehicle 1 may be any other type of mobility, such as a hybrid electric vehicle (HEV) or a plug-in hybrid electric vehicle (PHEV).

The second lane L2 is where a compact mobility 2 can travel at a low speed. The compact mobility 2 is, for example, a personal mobility having a passenger capacity of 1 person. The compact mobility 2 may be, for example, a full-automation mobility for carrying a load. Note that the compact mobility 2 corresponds to a “movable body” according to the present disclosure. In the present embodiment, a wireless power transmission system 10 is installed on the second lane L2.

The third lane L3 is a pedestrian 3 only lane. The third lane L3 is provided adjacent to the second lane L2. Note that the term “pedestrian,” as used in the present disclosure, refers to people traveling on foot in general, not necessarily focusing on the ambulatory movement. The “pedestrian” can include those who are running or standing still on any of the lanes.

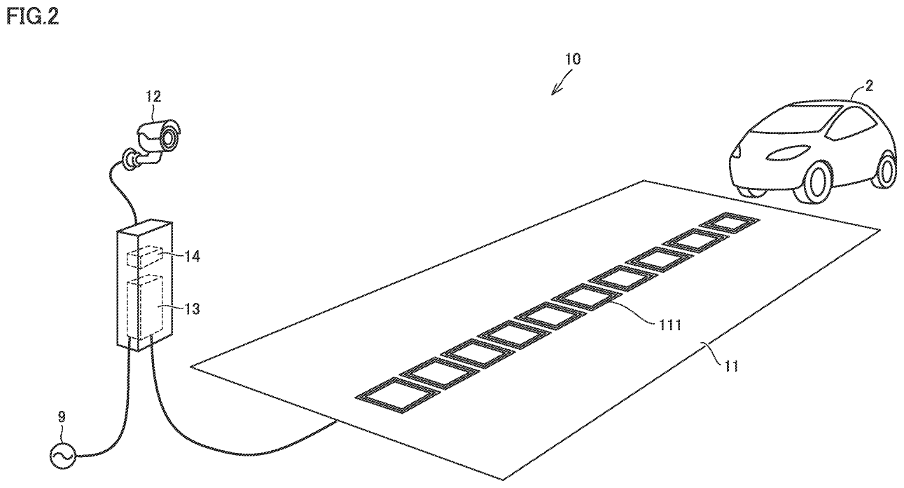

FIG. 2 is a diagram illustrating one example configuration of a wireless power transmission system 10. The wireless power transmission system 10 includes a ground unit 11, a sensor unit 12, a power conversion unit 13, and a controller 14.

The ground unit 11 is disposed on (e.g., buried in) the road surface of a driving lane (the second lane L2) for the compact mobility 2. The ground unit 11 includes multiple transmitter coil units 111. The transmitter coil units 111 are each capable of wireless power transfer to the compact mobility 2, in accordance with a control signal from the controller 14, if the compact mobility 2 is located above the transmitter coil unit 111. While FIG. 2 illustrates ten transmitter coil units 111 arranged in one line, it should be noted that the number of transmitter coil units included in the ground unit 11 and the arrangements of the transmitter coil units are not particularly limited. The transmitter coil units 111 may be arranged in two or more lines. Note that the ground unit 11 corresponds to a “power transmission device” according to the present disclosure.

The sensor unit 12 detects the location of the compact mobility 2 passing through over the ground unit 11, and outputs a detection signal to the controller 14. The sensor unit 12, for example, includes at least one of a camera, a radar, and a LIDAR (Laser Imaging Detection And Ranging) (none of which are shown). Note that, instead of one sensor unit 12 being provided for the ground unit 11, a sensor (such as an optical sensor or a weight sensor) for detecting the location of the compact mobility 2 may be provided for each transmitter coil unit 111.

The power conversion unit 13 is electrically connected to an external alternating-current (AC) power supply 9 (typically, a commercial power supply). The power conversion unit 13 converts the voltage of an AC power supplied from the AC power supply 9 into an appropriate value. The power conversion unit 13 then outputs the AC power obtained by the conversion to a selected one of the transmitter coil units 111 included in the ground unit 11. The power conversion unit 13 may also be buried in the road surface.

The controller 14 is capable of two-way communications with a management server (not shown) via a communication module, and controls the power conversion unit 13 in accordance with commands from the management server. More specifically, the controller 14 locates the compact mobility 2, based on a detection signal from the sensor unit 12. The controller 14 then controls the power conversion unit 13 so that an AC power is output to a transmitter coil unit that is located under the compact mobility 2, among the transmitter coil units 111. For example, if the compact mobility 2 is detected above a certain transmitter coil unit, the controller 14 selects this transmitter coil unit. Doing so passes an AC current through the transmitter coil included in the transmitter coil unit, thereby forming an electromagnetic field around the transmitter coil. This transfers electric power to the receiving coil within the power receiving device 22 (described later) included in the compact mobility 2 (wireless charging). Subsequently, if the compact mobility 2 is no longer detected above the transmitter coil unit, the controller 14 unselects the transmitter coil unit, thereby stopping the AC power from being output to the transmitter coil unit. Such a set of controls is performed for each transmitter coil unit, thereby allowing wireless power transfer to the vehicle 4 even while the compact mobility 2 is traveling. The electric power can be, of course, wirelessly transmitted to the compact mobility 2 while the compact mobility 2 is stopped. Note that the controller 14 may also be buried in the road surface.

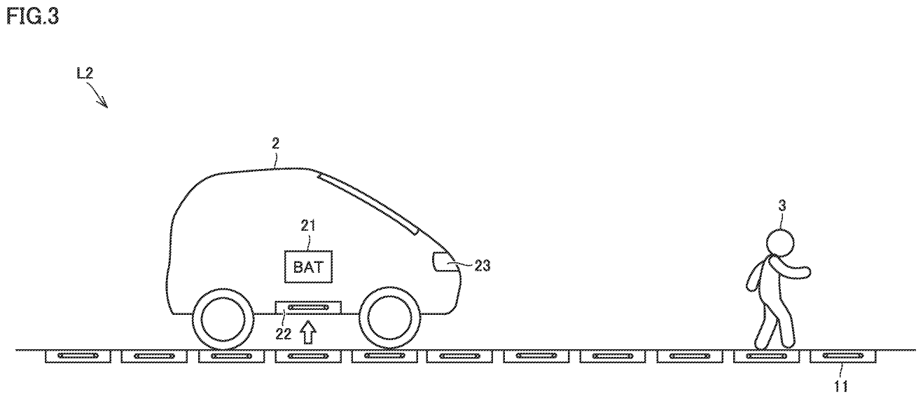

FIG. 3 is a diagram illustrating one example mode of the second lane L2. The compact mobility 2 is an electric-powered mobility capable of wirelessly receiving electric power for traveling. The compact mobility 2 includes a battery 21, a power receiving device 22, and a notification unit 23.

The battery 21 is an assembled battery formed of multiple cells. Each cell is a secondary battery, such as a lithium-ion battery or a nickel-hydrogen battery. The battery 21 supplies a motor generator (not shown) with electric power for generating a driving force for the compact mobility 2. The battery 21 also stores electric power that is generated by the motor generator.

In the example shown in FIG. 3, the power receiving device 22 is disposed on the lower surface of a floor panel forming the bottom surface of the compact mobility 2. A receiving coil is accommodated within the power receiving device 22. The receiving coil wirelessly receives electric power that is transmitted from the wireless power transmission system 10. The AC power received by the power receiving device 22 is converted into a direct-current (DC) power by an inverter (not shown) and charged to the battery 21.

In the present embodiment, an amount of electric power that can be stored in the battery 21 is less than a predetermined value. Accordingly, with the electric power stored in the battery 21, the compact mobility 2 can travel only a small distance. The majority of electric power that is consumed by the compact mobility 2 during traveling is one received by the compact mobility 2 from the wireless power transmission system 10. Thus, the electric power stored in the battery 21 is merely consumed secondarily. Stated differently, since the compact mobility 2, basically, travels by consuming, as is, the electric power required from the wireless power transmission system 10, the upper speed limit for the compact mobility 2 depends on an amount of electric power received from the wireless power transmission system 10. Note that the battery 21 is not a necessarily component for the compact mobility 2. The power storage device, such as the battery 21, may not be mounted on the compact mobility 2. It can also be said for the compact mobility 2 having no power storage device mounted thereon that “the amount of electric power that can be stored is smaller than a predetermined amount.”

The notification unit 23 notifies the pedestrian 3 of changes in speed of the compact mobility 2. More specifically, the notification unit 23 is, for example, a lamp or indicator externally, visually recognizable, and lights on when the speed of the compact mobility 2 decreases. The notification unit 23 may be a display that shows a message indicating that the speed of the compact mobility 2 has decreased. The notification unit 23 may also be a loudspeaker that provides audibly output indicating that the speed of the compact mobility 2 has decreased.

<Sensing of Pedestrians>

As mentioned above, while the second lane L2 is a driving lane for the compact mobility 2, the adjacent third lane L3 is dedicated to the pedestrian 3. Accordingly, the pedestrian 3 may enter the second lane L2 and temporality walks in the second lane L2. Alternatively, the second lane L2 may be a shared driving lane for the purpose of the compact mobility 2 and the pedestrian 3 existing at the same driving lane. Under such circumstances, the focus is how to ensure the safety and comfort of the pedestrian 3. In the present embodiment, if the pedestrian 3 is sensed in the second lane L2, the wireless power transmission from the wireless power transmission system 10 to the power receiving device 22 is reduced, as compared to when no pedestrian 3 is sensed in the second lane L2, thereby forcing the compact mobility 2 to reduce the speed.

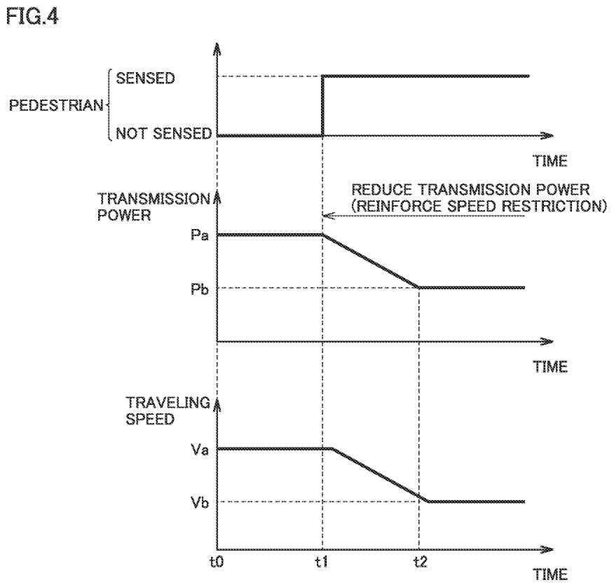

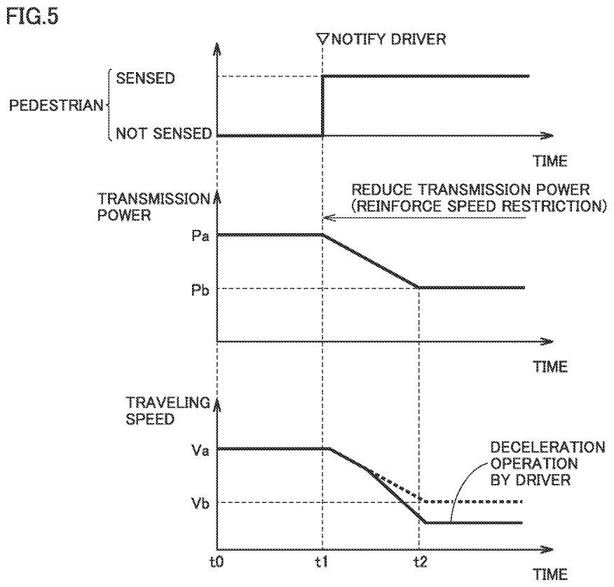

FIG. 4 is a diagram illustrating one example of a time course of transmission power from the wireless power transmission system 10 and a time course of a traveling speed of the compact mobility 2. Represented on the horizontal axes of FIG. 4 and FIG. 5 (described later) are elapsed times. Represented on the vertical axis are, from top to bottom, whether the pedestrian 3 is sensed in the second lane L2 or not, the transmission power from the wireless power transmission system 10 to the compact mobility 2, and the traveling speed of the compact mobility 2. At an initial time t0, no pedestrian 3 is sensed. Assume that the compact mobility 2 travels at a speed Va, consuming a transmission power Pa from the wireless power transmission system 10.

At a time t1, the controller 14 senses the pedestrian 3 in the second lane L2, using the sensor unit 12. Note that, desirably, the distance at which the controller 14 senses the pedestrian 3 is longer than a distance at which the compact mobility 2 and the pedestrian 3 can collide without activation of the pre-crash safety system (autonomous damage mitigation breaking system) of the compact mobility 2 (e.g., a dozen or so meters to tens of meters). The range in which the pedestrian 3 can be sensed is not limited to the planned travel route for the compact mobility 2. Desirably, such a range has certain flexibility so as to encompass areas slightly outside the planned travel route for the compact mobility 2.

If sensed the pedestrian 3, the controller 14 reduces the transmission power from the wireless power transmission system 10 (more specifically, the transmitter coil unit 111 immediately below the travel route of the compact mobility 2) to the compact mobility 2 from Pa to Pb. As shown in FIG. 4, desirably, sudden change in transmission power is avoided, for example, by reducing the transmission power at a predetermined rate (slope) or over a predetermined period of time. With the reduction in transmission power, the electromagnetic field generated by the wireless power transmission system 10 is weaken. Thus, the impact that can be caused by the electromagnetic field onto the pedestrian 3 can be mitigated. The wireless power transmission system 10 can also save power.

In addition, as mentioned above, the compact mobility 2, basically, travels by consuming the electric power received from the wireless power transmission system 10, rather than consuming the electric power stored in the battery 21. Accordingly, the reduction in transmission power from the wireless power transmission system 10 from Pa to Pb reduces the traveling speed (here, the traveling speed=the upper speed limit) of the compact mobility 2 from Va to Vb, with a certain time delay. Doing so reduces the running noise of the compact mobility 2. Thus, the pedestrian 3 can be less surprised or feel less scared of the compact mobility 2 passing by near the pedestrian 3.

FIG. 5 is another diagram illustrating another example of a time course of transmission power from the wireless power transmission system 10 and a time course of a traveling speed of the compact mobility 2. The controller 14 may notify the driver that the transmission power from the wireless power transmission system 10 is to be reduced (or the pedestrian 3 is sensed). This allows the notified driver to manually perform a deceleration operation of the compact mobility 2. With the deceleration operation, the traveling speed of the compact mobility 2 is further reduced, thereby further reducing the running noise of the compact mobility 2. As a result, the pedestrian 3's feeling of surprise and/or fear can further be lessened.

<Process Flow>

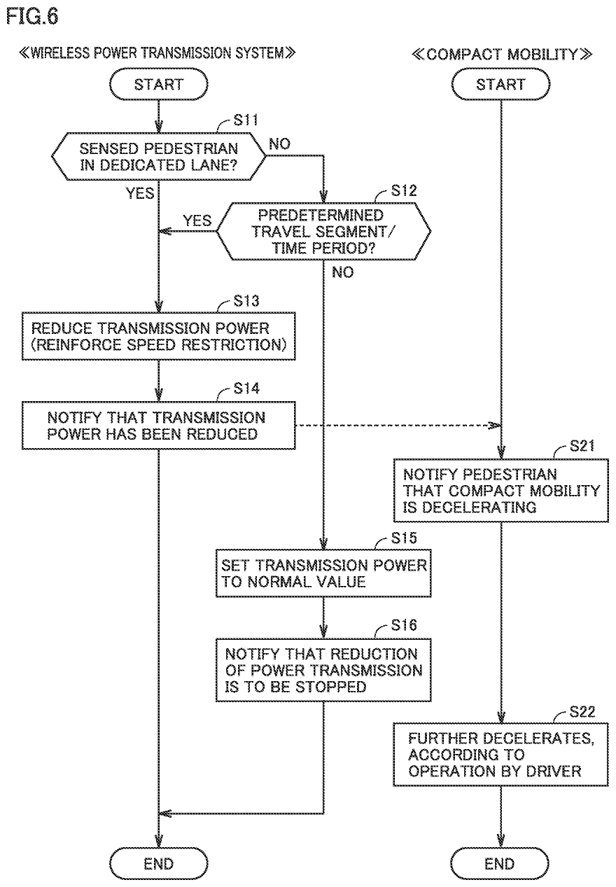

FIG. 6 is a flowchart illustrating a procedure of a power transmission process according to the present embodiment. In the figure, shown on the left side is a set of process steps performed by the wireless power transmission system 10 (the controller 14), and shown on the right are process steps performed by the compact mobility 2. The process steps shown in this flowchart are invoked from the main routine (not shown) and executed once predetermined conditions are met, for example. Each process step, performed by the wireless power transmission system 10, is implemented by software processing by the controller 14. However, each process step may be implemented by hardware (a circuitry) disposed within the controller 14. Hereinafter, each process step is abbreviated as S.

In S11, based on a detection signal from the sensor unit 12, the controller 14 determines whether the pedestrian 3 is sensed in the second lane L2. If the pedestrian 3 is sensed in the second lane L2 (YES in S11), the controller 14 proceeds to S13. Even if no pedestrian 3 is sensed in the second lane L2 (NO in S11), the controller 14 proceeds to S13 if the compact mobility 2 is traveling on a predetermined travel segment during a predetermined period of time, in which the surroundings of the second lane L2 are congested (YES in S13).

In S13, the controller 14 reduces the transmission power from the wireless power transmission system 10 to the compact mobility 2, as compared to when no pedestrian 3 is sensed in the second lane L2. This decelerates the compact mobility 2. Furthermore, the controller 14 notifies the compact mobility 2 that the transmission power has been reduced (S14).

Upon receiving the notification, the compact mobility 2 uses the notification unit 23 to notify the surrounding pedestrian 3 that the compact mobility 2 is decelerating (S21). This allows the pedestrian 3 to know that the compact mobility 2 is sensing him/her, allowing him/her to experience the feeling of comfort. For example, if the compact mobility 2 is a fully autonomous vehicle, the pedestrian 3 is unable to know, by eye contact with the driver, whether he/she is recognized by the driver. Accordingly, it is particularly important that the pedestrian 3 experiences the feeling of comfort by the notification from the notification unit 23.

Furthermore, upon receiving the notification, the driver of the compact mobility 2 may implement a deceleration operation on the compact mobility 2. Doing so further decelerates the compact mobility 2, according to the deceleration operation by the driver (S22).

Note that, if no pedestrian 3 is sensed in the second lane L2 (NO in S11) and the second lane L2 is not a travel segment around which people are crowded or the time period is not one where people are crowded (NO in S12), the controller 14 sets the transmission power from the wireless power transmission system 10 to the compact mobility 2 to a normal value (S15). The normal value is determined, depending on the specifications of the compact mobility 2, a posted speed limit for the second lane L2, etc. In this case, the controller 14 may notify the compact mobility 2 that the reduction of the power transmission from the wireless power transmission system 10 to the compact mobility 2 is to be stopped (S16). Although not shown, the compact mobility 2 having received the notification can accelerate, in accordance with an acceleration operation by the driver, within a speed range in which the compact mobility 2 can output with the electric power received from the wireless power transmission system 10.

As described above, in the present embodiment, if the pedestrian 3 is sensed in the second lane L2, the transmission power from the wireless power transmission system 10 to the compact mobility 2 is reduced and the compact mobility 2 is decelerated, as compared to when no pedestrian 3 is sensed in the second lane L2. Reducing the transmission power from the wireless power transmission system 10 can mitigate the impact that can be caused on the pedestrian 3 by the electromagnetic field formed around the wireless power transmission system 10. Decelerating the compact mobility 2 can also lessen the feeling of fear that the pedestrian 3 may experience due to the running noise of the compact mobility 2. Thus, according to the present embodiment, the safety and comfort of the pedestrian 3 can be ensured under circumstances in which the pedestrian 3 is present around the wireless power transmission system 10.

If the compact mobility 2 is of an unsealed version (e.g., if no doors are provided on the sides of the compact mobility 2), the electromagnetic field generated by the wireless power transmission system 10 may have an impact on the driver in the compact mobility 2 in some situations. According to the present embodiment, in addition to the pedestrian 3, the driver of the compact mobility 2 can also be protected from the electromagnetic field.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power transfer system, comprising:
a movable body;
a power transmission device capable of wireless power transfer, the power transmission device being installed on a driving lane for the movable body; and
a controller that controls the power transmission device, wherein
the movable body has an amount of electric power that can be stored less than a predetermined amount, and travels at an upper speed limit dependent on the electric power wirelessly received from the power transmission device,
when a pedestrian is sensed in the driving lane, the controller forces the movable body to decelerate by reducing transmission power from the power transmission device to the movable body, as compared to when the pedestrian is not sensed in the driving lane.

2. The power transfer system according to claim 1, wherein
the controller controls the movable body to decelerate by reducing the transmission power from the power transmission device to the movable body during a predetermined time period, as compared to other time period.

3. The power transfer system according to claim 1, wherein
the controller gives notification to the movable body, indicating that the transmission power from the power transmission device to the movable body has been reduced, and
upon receiving the notification, the movable body further decelerates, in accordance with an operation performed by a driver of the movable body.

4. The power transfer system according to claim 1, wherein
the movable body includes a notification unit that notifies the pedestrian that the movable body has decelerated with reduction of the transmission power from the power transmission device.

5. A power transmission system for transmitting electric power to a movable body, wherein
the movable body has an amount of electric power that can be stored less than a predetermined amount, and travels at an upper speed limit dependent on electric power wirelessly received,
the power transmission system, comprising:
a power transmission device disposed on a driving lane for the movable body, the power transmission device being capable of wireless power transfer to the movable body; and
a controller that controls the power transmission device; wherein
when a pedestrian is sensed in the driving lane, the controller forces the movable body to decelerate by reducing transmission power from the power transmission device to the movable body, as compared to when the pedestrian is not sensed in the driving lane.

6. A method for transferring electric power from a power transmission device to a movable body, wherein
the power transmission device is disposed on a driving lane for the movable body, the power transmission device being capable of wireless power transfer to the movable body, and
the movable body has an amount of electric power that can be stored less than a predetermined amount, and travels at an upper speed limit dependent on the electric power wirelessly received from the power transmission device,
the method comprising:
sensing a pedestrian in the driving lane; and
forcing, when the pedestrian is sensed in the driving lane, the movable body to decelerate by reducing transmission power from the power transmission device to the movable body, as compared to when the pedestrian is not sensed in the driving lane.
